(19) United States
(12) Patent Application Publication
(10) Pub. No.: US 2008/0053928 A1
(43) Pub. Date: Mar. 6, 2008

(54) Lumber storage and stacking apparatus and method stacking

(76) Inventor: David Klauer, Denton, TX (US)

Correspondence Address: John E. Vandigriff, 906 Stone Circle Ln., Lewisville, TX, 75056, US

(21) Appl. No.: 11/824,343

(22) Filed: Jul. 2, 2007

Related U.S. Application Data
(60) Provisional application No. 60/842,104, filed on Sep. 5, 2006.

(51) Int. Cl. B65G 1/02; B65G 57/00

(52) U.S. Cl. 211/49.1; 414/802

(57) ABSTRACT

Several devices are used in safely moving lumber and restocking lumber storage/display racks, and a method for restocking lumber in the storage/display rack is used to safely removed and replace partial lumber bundles over new bundles or lumber. As lumber is sold and taken from the rack, it has to be replaced. The remaining pieces of a stack bundle, a partial bundle, is removed by a fork lift using pull arms attached at each end of the forklift carriage/backrest. The pull arms assure that all of the remaining pieces of the stacked bundle can be safely picked up by the forklift to be set aside. A bundle of lumber is then placed on the rack. The partial bundle is then picked up and placed on the new bundle.

### PRIORITY

Priority is claimed from Provisional Application Ser. No. 60/842,104, filed Sep. 5, 2006.

### FIELD OF THE INVENTION

The invention relates to the stacking and storing of lumber, and to an apparatus for safely moving and storing lumber when restocking lumber storage racks, and to a method of safely moving and stacking lumber.

### BACKGROUND OF THE INVENTION

Lumber is usually stored inside buildings at stores that sell building material and related products. The lumber is stored in cantilevered rack that have extend arms forming a bin or bay, with several banded stacks of lumber in each rack. After lumber has been removed from the rack, it is necessary to restock lumber. There are a number of pieces of loose lumber pieces that have to be removed before a new banded stack of lumber is placed in the rack. Thereafter, the loose lumber is replaced on the new bundled stack of lumber.

U.S. Pat. No. 5,875,905 describes a cantilevered support arm that is used in a storage rack system. The rack system is one type that is used to store lumber in a store that sells lumber. Other types of racks include I-beam arms forming a rack.

### SUMMARY OF THE INVENTION

The invention relates to devices for safely moving lumber and restocking lumber storage/display racks, and to a method for restocking lumber in the storage/display rack. As lumber is sold and taken from the rack, it has to be replaced. The remaining pieces of a stack bundle, a partial stack, is removed by pull arms that are attached to the forklift and at the back of the partial stack pulling it forward to ensure that all pieces of lumber can be picked up by the forklift. This partial stack is placed on wooden supports, for example, on the floor allowing the forklift to later pick them up. A banded bundle is then picked up and placed on the rack. The partial stack is then picked up and placed on the banded bundle. Vertical poles are attached to the support arms of the storage rack. The partial stack is then pulled forward against the vertical poles allowing the partial stack to remain on top of the banded bundle as the forklift is backed away. Vertical poles are removed, and smaller poles are replace.

The technical advance represented by the invention as well as the objects thereof will become apparent from the following description of a preferred embodiment of the invention when considered in conjunction with the accompanying drawings, and the novel features set forth in the appended claims.

### BRIEF DESCRIPTION OF THE DRAWINGS

FIG. 1 Shows a storage rack of the prior art;

FIG. 2 is a front view of the rack of FIG. 1;

FIG. 3 is a side view shown the rack with bundles of lumber;

FIG. 4 shows a storage rack with the lumber retaining poles attached;

FIG. 5 shows the rack of FIG. 4 with lumber stored thereon;

FIG. 6 shows a vertical pole attachment;

FIG. 7 shows the attachment of FIG. 6 attached to the end of a horizontal I-beam arm;

FIG. 8 shows a different embodiment of a pole attachment device;

FIG. 8a shows another embodiment of a pole attachment device;

FIG. 9 shows the device of FIG. 8 attached to the end of a horizontal arm;

FIG. 10 shows another pole attachment device;

FIG. 11 shows the device of FIG. 10 attached to the end of a horizontal arm;

FIG. 12 shows a device used with a forklift to move lumber; and

FIG. 13 shows the devices of FIG. 12 and how they are positioned in relation to the stack of lumber.

### DESCRIPTION OF A PREFERRED EMBODIMENT

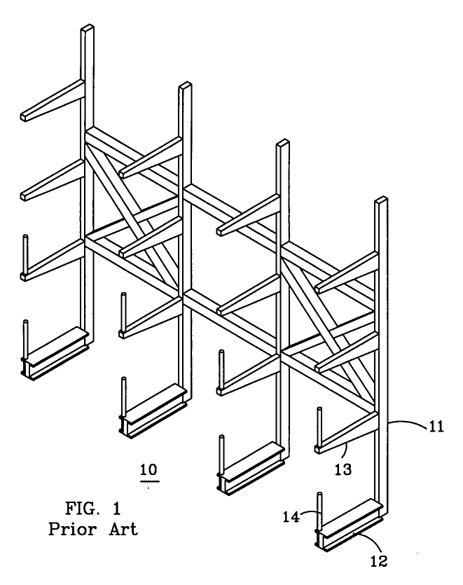

FIG. 1 is an isometric view and shows a prior art rack that can be used to store and display lumber. Rack 10 includes vertical members 11 and horizontal members 12 and 13. Member 12 maybe, for example, an I-beam. There are a plurality of these members to form the rack. A pole 14 is inserted in an opening at the end of each horizontal member to prevent lumber stored on the horizontal members from falling from the rack.

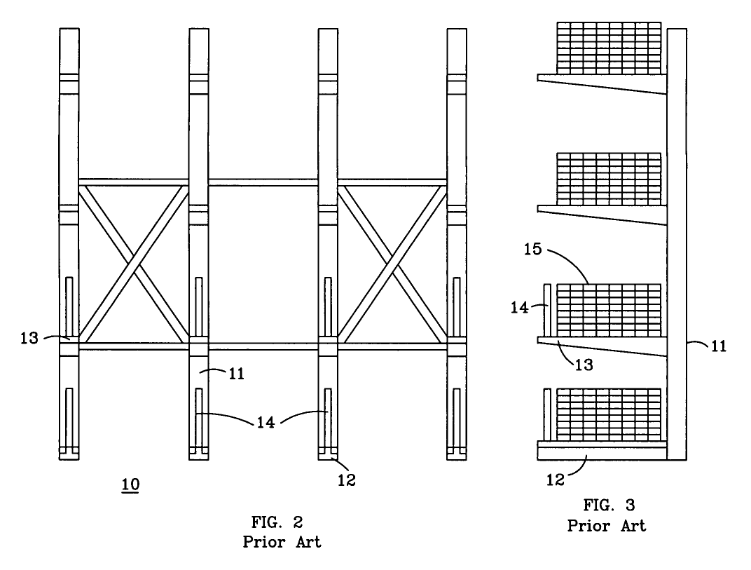

FIG. 2 is a front view of rack 10 showing the four vertical members 11, each having one horizontal member 12 which serves as the foot or bottom support, and three horizontal members 13 which, along with member 12 are used to support lumber. Poles 14 are inserted in holes in the horizontal members.

FIG. 3 is a side view of the rack 10 showing lumber mounted in the rack, each bundle on horizontal arm 12 and arms 13. A pole 14 is mounted in an opening in the end of each horizontal to prevent lumber from falling from the rack.

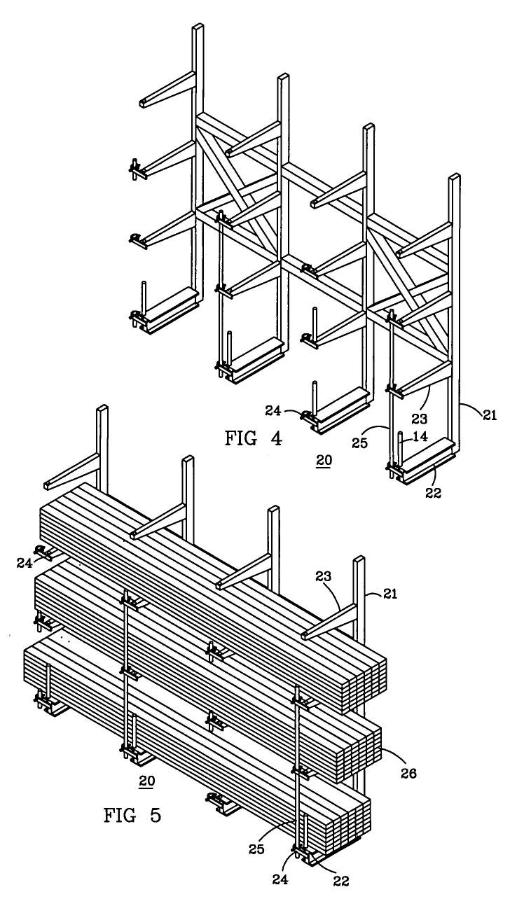

FIG. 4 shows a rack 20 which has an attachment 24 mounted on the end of the horizontal members 23, each horizontal member attached to a vertical member 21. As shown in FIGS. 4 and 5, a vertical rod or pole 25 is attached, at least temporarily, to attachment 24. Pole 25 prevents lumber from being pulled from rack 20 during the loading of lumber, and as it is pulled forward to the front of the rack 20.

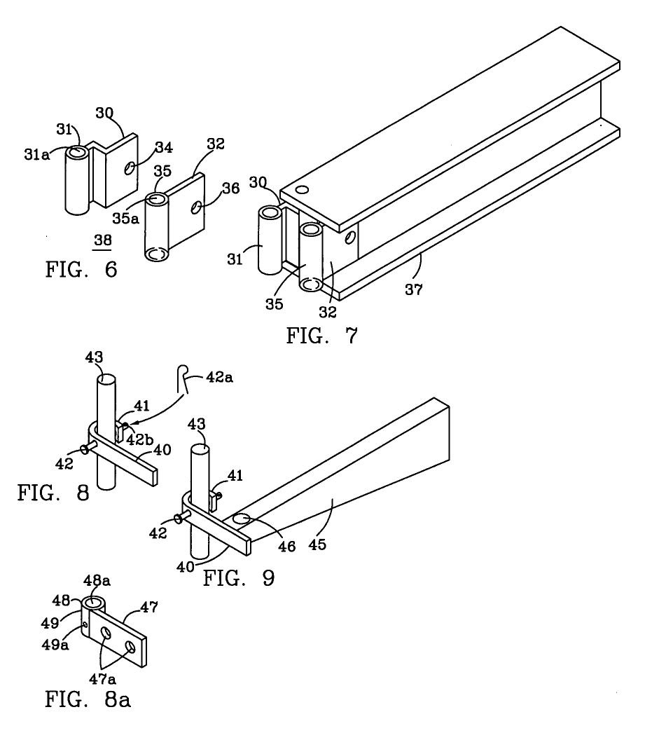

FIGS. 6 and 7 show a device 38 mounted on the end of a horizontal I-beam arm 37, for example, an arm such as arm 22 shown in FIG. 5. Device 38 includes two parts 30 and 32 that are secured to horizontal unit 37. Part 30 includes a cylindrical part 31 that has an opening 31a, and an opening 34 used to secured it to arm 37. Part 32 has a cylindrical part 35, with an opening 35a, and an opening 36 which permits it to be attached to arm 37. Both parts 30 and 32 are attached to arm 37. The openings 31a and 35a allow rods, such as the rods 25, FIG. 5 and rod 14, FIG. 1, to be mounted in the openings.

FIGS. 8 and 9 show another device for securing to the end of a horizontal arm 45. This arm may be for example, arm 23 shown in FIG. 4. Device 40 has a curved end 41 through which a pin 42 may be inserted to secure a rod 43 within the curved portion of device 40. Device 40 is secured to the end of arm 45. In use, a rod 43 is temporarily secured in curved end 41, wherein rod 43 may correspond to rod 25 in FIG. 4. Rod 43 has an opening 42b through which a pin 42a may be inserted to retain pin 42 in place. Arm 45 may also have an opening 46 in which another rod may be placed, for example, a rod 14 shown in FIG. 1.

FIG. 8a show another device 47 which may be attached to, for example, the end of arm 45. Device 47 has a tubular part 48 with opening 48a for inserting a rod. A pin 42 (FIG. 8) may be inserted though opening 49a to secure a rod.

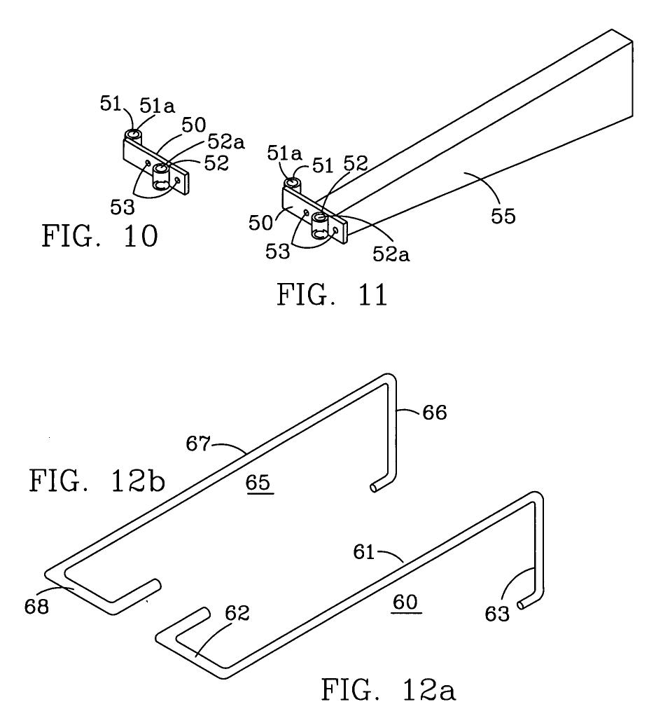

Another embodiment of a device that is secured to the end of a horizontal arm is shown in FIGS. 10 and 11. A device 50 has two cylindrical parts 51 and 52. Each part 51 and 52 have openings 51a and 52a, respectively, in which rods may be mounted. Device 50 is secured to the end of an arm 55, for example, by screws or bolts, not illustrated, extending through openings 53. A rod, for example rod 25 of FIG. 4, may be placed in openings 51a, and a rod 14, FIG. 1, may be placed in opening 52a.

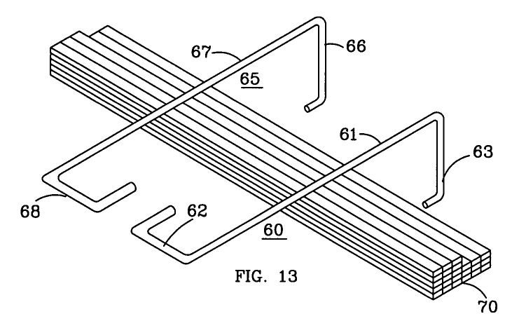

FIGS. 12a and 12b shows two rods 60 and 65 that are used to pull a partial bundle, for example, the partial bundle shown in FIG. 13. When a bundle of lumber is place in a rack, it may be pulled forward against, for example, rods 25 FIG. 5, to bring the lumber to the front part of the rack, allowing easy access. Also, when a partial bundle is removed from a rack and a new bundle is placed in the rack, the partial bundle is then placed on the new bundle and pulled forward against rods 25 to provide easy access to the lumber. After being pulled forward, the rods 25 are removed, leaving, for example, only the rods 14 to prevent lumber from accidently falling from the rack.

In use, rods 60 and 65 are attached to a forklift with the ends 62 and 62, placed around vertical members on the fork lift carriage (not illustrated). The ends 63 and 66 are placed behind the partial lumber bundles (FIG. 13) and then the forklift moves backward pulling the lumber to the front of the rack.

A method of restocking lumber in the racks shown in FIGS. 4 and 5, is as follows. A partial stack or bundle of lumber is removed with a forklift and placed on the floor on strips of lumber to allow lifting the partial lumber at a later time. Then the rack is restocked with full bundles of lumbers. Two or more spacers are placed on the full bundles of lumber, and the partial stack is then picked up by the forklift and placed over the full bundle of lumber on the spacers.

At least two rods, for example rods 25, FIGS. 4 and 5, are secured to the horizontal members, for example 22, 23, FIGS. 4-5. The forklift is then backed away from the rack leaving the partial stack of limber on top of the new banded bundle. Rods 25 are removed, but rods 14, FIG. 1 are replaced to prevent the accidental falling of lumber from the rack. Bundle bands that are around the full bundles are removed to allow the lumber to be removed. It is possible to removed the bands because of the spacers placed on top of the new full bundle prior to placing the partial bundle on top of the new bundle.

This process is repeated for each shelf of the racking being restocked.

What is claimed:

1. A storage rack for storing lumber, comprising
a plurality of vertical members,
a plurality of horizontal members, there being at least two vertical members secured to each vertical members,
a securing device attached to a free end of each of the horizontal members, each securing device having at least one opening therein;
at least two vertical poles for temporarily securing to the horizontal members through the opening in the securing device.

2. The storage rack according to claim 1, wherein the vertical poles are secured in the securing device with a pin.

3. The storage rack according to claim 1, wherein each securing device has two vertical pole holding openings.

4. The storage rack according to claim 1, wherein the securing devices are tubular members into which the vertical poles are mounted.

5. The storage rack according to claim 1, including pull rods used in conjunction with a lumber loading vehicle to help position a lumber bundle on the storage rack.

6. The storage rack according to claim 5, wherein the pull rods are angled on each end for attaching to the lumber loading vehicle, and for positioning behind a lumber bundle for moving it.

7. The method for stocking and restocking lumber in a storage rack, comprising the steps of:
remove Safety poles;
install pull arms over partial bundle and attach to The storage rack according to claim 1, both sides of forklift carriage/backrest;
remove partial bundle by raising forklift forks slightly above cantilever base/arm and slowly back up until all partial bundle can be safely picked up by the forklift;
partial bundle is placed on wooden supports, for example, on the floor to allow the forklift to later pick them up;
a banded bundle of lumber is then placed on the empty rack;
two or three wooden strips are placed on top of the banded bundle of lumber; and
the partial bundle is then picked up, for example, off of the floor and placed on the banded bundle of lumber.

8. The method according to claim 7, wherein vertical lumber retention poles are attached to end pieces that have been added to the ends of the support arms and/or existing support base safety pole holes;
vertical lumber retention poles hold the partial bundle in place on top of the banded bundle, as the forklift backs away from the rack;
the vertical lumber retention poles are removed, and the safety poles are replaced; and
bands are cut and removed from the banded bundle, leaving a fully stocked rack.

9. The method according to claim 7, including the step of moving the banded bundle of lumber forward with pull rods to position the lumber bundle at the front of the storage rack.

10. The method according to claim 9, wherein the pull rods are attached to a lumber moving vehicle and extend behind the lumber bundle to pull it to the front of the storage rack.
